(19) United States
(12) Patent Application Publication
(10) Pub. No.: US 2026/0327927 A1
(43) Pub. Date: Oct. 22, 2026

(54) Impact Absorbing Bollard

(71) Applicant: McCue Corporation, Danvers, MA (US)

(72) Inventors: Thomas Ustach, Boston, MA (US); Timothy David Stratford, Milton Keynes (GB); Teodoro A. Mesa, Lynn, MA (US)

(21) Appl. No.: 19/645,642

(22) Filed: Apr. 13, 2026

Related U.S. Application Data
(60) Provisional application No. 63/789,630, filed on Apr. 16, 2025.

(51) Int. Cl. E01F 9/627; B60L 53/31

(52) U.S. Cl. CPC E01F 9/629; B60L 53/31

(57) ABSTRACT

An impact-absorbing bollard includes a post having a first end and a second end, the post having a flange disposed at the first end a two-part bumper assembly including a first part having a first interior wall, the first interior wall defining a first cavity sized and shaped to receive a first half of the second end of the post, and a first number of open channels within the first part, a second part having a second interior wall, the second interior wall defining a second cavity sized and shaped to receive a second half of the second end of the post, and a second number of open channels within the second part, wherein, when the two-part bumper assembly is assembled the first cavity and the second cavity form an assembled cavity that is sized and shaped to receive the second end of the post and has an opening through which the post extends out of the bumper assembly, and at least some channels of the first number of open channels align with at least some channels of the second number of open channels to form closed channels that extend through the bumper assembly; and at least one anchor assembly configured to extend through the two-part bumper assembly and the flange of the post to anchor the apparatus to a surface.

### CROSS-REFERENCES TO RELATED APPLICATIONS

This application claims the benefit of U.S. Provisional Application No. 63/789,630 filed Apr. 16, 2025, the entire contents are hereby incorporated herein by reference.

### BACKGROUND OF THE INVENTION

This invention relates to an impact-absorbing bollard.

As electric vehicles grow in popularity, the demand for electric vehicle chargers also grows. Electric vehicle chargers are often installed upon slabs placed at the end of a parking space, where an electric vehicle uses a charging cable extending from the electric vehicle charger (similar to a gas pump for non-electric vehicles) to charge the electric vehicle. Since the electric vehicle chargers on these slabs are often positioned near parking spaces, the electric vehicle chargers face a potential risk of accidental impact from a vehicle using the parking space for electric vehicle charging or otherwise.

Electric vehicle chargers are often both fragile and expensive, and so mitigating the risk of accidental impact from a vehicle as much as possible can be of particular importance to entities installing and/or operating such electric vehicle chargers. One approach to mitigating risk of accidental contact between vehicles and an electric vehicle charger includes positioning the charger further from the parking space. However, doing so increases the length of the charging cable, which is expensive because the materials used to manufacture such cables are costly.

### SUMMARY OF THE INVENTION

Aspects described herein are directed to a bollard for installation on a slab that supports an electric vehicle charger and/or houses infrastructure (e.g., wiring) for electric vehicle charging. In general, the bollard has an impact-absorbing anchoring mechanism that is configured to receive an impact from a vehicle in a way that minimizes or prevents damage to the vehicle, the electric vehicle charger, the slab, and the bollard itself.

In a general aspect, an impact-absorbing bollard includes a post having a first end and a second end, the post having a flange disposed at the first end; a two-part bumper assembly including a first part having a first interior wall, the first interior wall defining a first cavity sized and shaped to receive a first half of the first end of the post, and a first number of open channels within the first part, a second part having a second interior wall, the second interior wall defining a second cavity sized and shaped to receive a second half of the first end of the post, and a second number of open channels within the second part, wherein, when the two-part bumper assembly is assembled, the first cavity and the second cavity form an assembled cavity that is sized and shaped to receive the first end of the post and has an opening through which the post extends out of the bumper assembly, and at least some channels of the first number of open channels align with at least some channels of the second number of open channels to form closed channels that extend through the bumper assembly; and at least one anchor assembly configured to extend through the two-part bumper assembly and the flange of the post to anchor the bollard to a surface.

Aspects may include one or more of the following features.

The two-part bumper assembly may have a circular shape and the first part and second part of the two-part bumper assembly may be semicircular, each having a flat side. Openings of the first number of open channels may be on the flat side of the first part of the two-part bumper assembly and the openings of the second number of open channels may be on the flat side of the second part of the two-part bumper assembly.

Channels of the first number of open channels and the second number of open channels may have a hexagonal shape. The first number of open channels and the second number of open channels may form a honeycomb structure in the two-part bumper assembly. A size and shape of the first number of open channels and the second number of open channels may vary across the two-part bumper assembly. A wall thickness of walls separating adjacent channels of the first number of open channels and a wall thickness of walls separating adjacent channels of the second number of open channels may vary across the two-part bumper assembly to define a stiffness gradient within the two-part bumper assembly.

The two-part bumper assembly may be formed from an elastomer material. The elastomer material may be ethylene propylene diene monomer rubber.

The first part of the two-part bumper assembly may have an upper portion and a lower portion and the at least one anchor assembly may hold the flange between the upper portion and the lower portion. The lower portion of the first part and a lower portion of the second part of the two-part bumper assembly may together elevate the flange above the surface when the impact-absorbing bollard is anchored to the surface, such that the post does not contact the surface during deflection of the post caused by an impact.

The at least one anchor assembly may include an anchor and a washer, the washer being sized to seat within an anchor receptacle defined in the two-part bumper assembly such that the washer prevents the anchor from passing entirely through the anchor receptacle and retains the flange captive between an upper portion and a lower portion of the two-part bumper assembly.

The impact-absorbing bollard may include one or more gussets connecting the post to the flange. The one or more gussets may be configured for insertion into the first cavity and the second cavity in a way that registers one or more openings in the flange with one or more openings in the two-part bumper assembly.

The impact-absorbing bollard may include a plastic cover configured to receive the post. The plastic cover may include one or more reflective elements disposed around an outer surface of the plastic cover.

The impact-absorbing bollard may include a signpost assembly attached to the second end of the post. The signpost assembly may include a coupler attached to the second end of the post and a signpost extending from the coupler, the signpost passing through an opening defined in the plastic cover.

In another general aspect, a method of protecting an electric vehicle charger installed on a surface includes anchoring an impact-absorbing bollard to the surface between a parking space and the electric vehicle charger. The anchoring includes positioning a two-part bumper assembly around a flange at a first end of a post of the impact-absorbing bollard, the two-part bumper assembly having a first part with a first number of open channels and a second part with a second number of open channels, wherein at least some channels of the first number of open channels align with at least some channels of the second number of open channels to form closed channels extending through the two-part bumper assembly, and driving at least one anchor through the two-part bumper assembly and the flange into the surface such that the flange is captured between an upper portion and a lower portion of the two-part bumper assembly.

In another general aspect, a system includes a slab; an electric vehicle charger installed on the slab; and an impact-absorbing bollard anchored to the slab between a parking space and the electric vehicle charger. The impact-absorbing bollard includes a post having a first end and a second end, the post having a flange disposed at the first end; a two-part bumper assembly formed from an elastomeric material, the two-part bumper assembly surrounding the first end of the post and including a first part having a first number of open channels and a second part having a second number of open channels, wherein at least some channels of the first number of open channels align with at least some channels of the second number of open channels to form closed channels extending through the two-part bumper assembly, the closed channels being configured to compress when the post is deflected by an impact; and at least one anchor extending through the two-part bumper assembly and the flange into the slab, wherein the two-part bumper assembly elevates the flange above a surface of the slab and absorbs impact energy through compression of the closed channels to reduce force transferred from the post into the slab.

Aspects may have one or more of the following advantages.

Aspects advantageously allow a bollard to be installed near an edge of a slab. In general, the slab is weaker near its edge and when a vehicle strikes a bollard there is a potential for the slab to break, damaging the slab and dislodging the bollard. Aspects described herein absorb an impact in an impact absorbing bumper assembly, reducing the amount of force transferred into the slab when the bollard is struck.

Aspects advantageously mitigate the risk of damage to electric vehicle chargers positioned near an edge of a slab while also reducing the necessary length of a charging cable of the electric vehicle charger. For example, the bollard can be installed near the edge of the slab where it impedes the ability of a vehicle to proceed past the bollard to strike the electric vehicle charger. The close proximity of the post of the bollard to the edge of the slab permits installation of the electric vehicle charger near the edge due to the reduced risk of impact from a vehicle. Positioning an electric vehicle charger nearer to the edge reduces the required length for the electric vehicle charger's charging cable, since an electric vehicle parked abutting the edge can get closer to the electric vehicle charger to charge. Cost concerns can limit the length of the cable or incentivize reducing the length of the cable, and so the ability to safely position the electric vehicle charger near the edge can be advantageous if not necessary to account for such cost concerns.

The impact-absorbing bollard is advantageously easy to install and designed to protect EV chargers, vehicles, and facilities. By using synthetic elastomers and high-strength steel, the bollard safely absorbs and withstands impacts to keep a designated area safe. The bollard advantageously prevents cracks in a concrete slab by absorbing energy from vehicle impacts without transferring energy down into the slab. The steel inner core is advantageously disposed relatively high off the concrete slab, allowing an impact to be gradually absorbed. Aspects advantageously protect vehicle bumpers due to impact absorption features and the plastic bumper cover.

Aspects advantageously provide a modular and field-serviceable design. Because the two-part bumper assembly has two discrete halves that clamp around the inner core in a clamshell fashion, individual components can be replaced after a severe impact. This reduces maintenance cost and minimizes downtime of the electric vehicle charger.

Aspects advantageously protect the installation surface by ensuring that the rigid steel inner core does not directly contact the slab surface during a typical vehicle impact. The lower compressible portions of the bumper assembly halves elevate the flange above the surface of the slab, so that impact forces are dissipated through compression of the elastomeric material before any rigid-to-rigid contact between the steel and the slab can occur.

Aspects advantageously provide a tunable stiffness profile. By varying the wall thickness and cell size of the honeycomb channels across the radial or vertical extent of the bumper assembly, the impact-absorbing bollard can be engineered to present a progressively stiffer response as deflection increases. This gradient response provides a soft initial contact that protects vehicle bumpers while providing increasing resistance to prevent the bollard from deflecting far enough to permit a vehicle to reach the electric vehicle charger.

Aspects advantageously allow the impact-absorbing bollard to serve a dual informational and protective function when equipped with the optional sign assembly, eliminating the need for a separate sign post adjacent to the electric vehicle charger, thereby reducing installation cost and site clutter.

Aspects advantageously provide compatibility with both pre-cast slabs having pre-formed anchor holes and field-drilled slabs, giving installers flexibility in a wide range of deployment scenarios.

Other features and advantages of the invention are apparent from the following description and from the claims.

### BRIEF DESCRIPTION OF THE DRAWINGS

FIG. 1 shows an impact-absorbing bollard positioned between an electric vehicle and a charging station.

FIG. 2 is an exploded view of the impact-absorbing bollard of FIG. 1.

FIG. 3 is a lower portion of the impact-absorbing bollard with an inner core located outside one piece of an impact-absorbing bumper assembly.

FIG. 4 is the lower portion of the impact-absorbing bollard with the inner core received in one piece of the impact-absorbing bumper assembly.

FIG. 5 is a cross-sectional view of the lower portion of the impact-absorbing bollard.

FIG. 6 is another embodiment of an impact-absorbing bollard.

### DETAILED DESCRIPTION

### 1 Overview

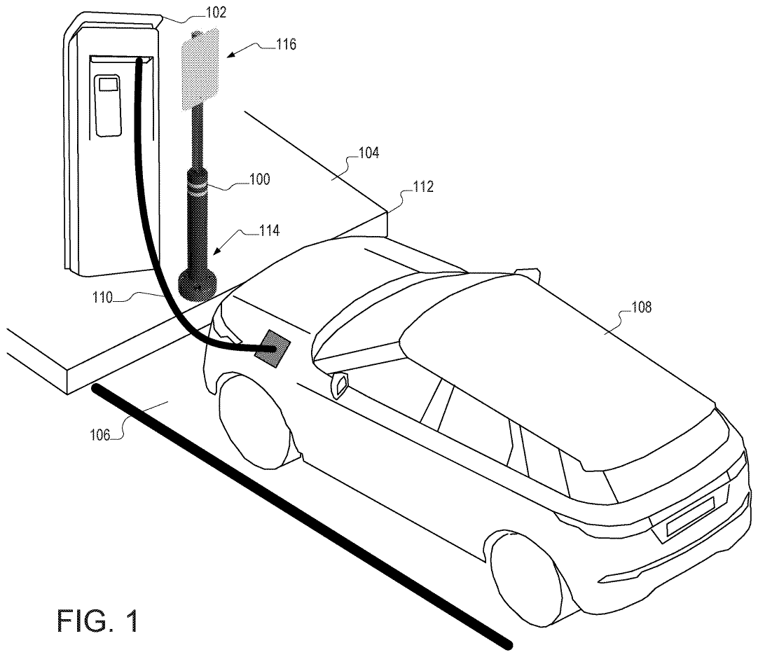

Referring to FIG. 1, an electric vehicle (“EV”) charger 102 is installed on a concrete slab 104 at one end of a parking space 106. The EV charger 102 is shown charging a vehicle 108 (e.g., an EV) parked in the parking space 106 through a charging cable 110.

An impact-absorbing bollard 100 is installed near a front edge 112 of the concrete slab 104, between the parking space 106 and the EV charger 102. If the vehicle 108 drives past the end of the parking space 106 toward the EV charger 102, the impact-absorbing bollard 100 is configured to (1) receive an impact from the vehicle to prevent the vehicle from striking the EV charger and (2) flex to prevent or minimize damage to the vehicle, the slab, and the impact-absorbing bollard.

### 2 Impact-Absorbing Bollard

In some examples, the impact-absorbing bollard 100 includes a post assembly 114 that is anchored near the front edge 112 of the slab 104 and a sign assembly 116 extending from a free end of the post assembly 114.

### 2.1 Post Assembly

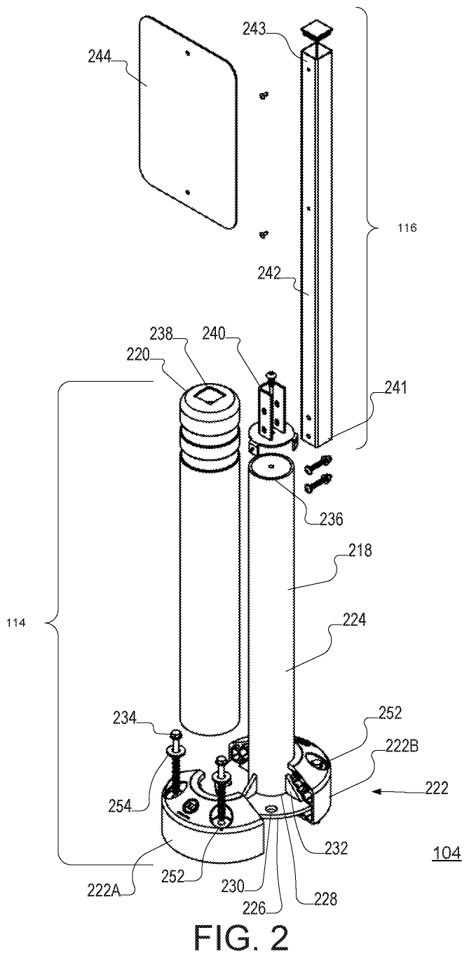

Referring to FIG. 2, the post assembly 114 includes an inner core 218, a plastic cover 220, and a two-part impact-absorbing anchoring assembly 222. The inner core 218 includes a hollow metal tube 224 with a flange 226 welded to it at the proximal end 228 of the inner core. The flange 226 includes a number of through-holes 230 that accommodate anchors 234 when the bollard 100 is attached to an installation surface. Reinforcing gussets 232 are welded to the hollow metal tube 224 and the flange 226 to strengthen the connection between the inner core 218 and the flange 226.

The reinforcing gussets 232 additionally serve a registration function during assembly of the bumper assembly 222 onto the inner core 218. Each semicircular half 222A, 222B of the bumper assembly 222 includes recesses or notches within the flange-receiving cavities 346A (described in greater detail below) that are shaped to receive corresponding ones of the gussets 232. When the two halves 222A, 222B are closed around the proximal end 228 of the inner core 218, the gussets 232 seat within these recesses and constrain the rotational position of the inner core 218 relative to the bumper assembly 222. This self-aligning feature ensures that the through-holes 230 in the flange 226 are automatically registered with the anchor receptacles 252 in the bumper assembly 222, simplifying installation and eliminating the need to manually align these features before inserting the anchors 234.

The plastic cover 220 is sized and shaped to slide onto and over the inner core 218 from its distal end 236. In some examples, the plastic cover includes an opening 238 (e.g., a square-shaped opening) through which a part of the sign assembly 116 extends, as is described in greater detail below.

In some examples, the plastic cover 220 includes one or more reflective rings or bands disposed around its outer circumference. The reflective rings increase the visibility of the impact-absorbing bollard 100 in low-light or nighttime conditions, alerting drivers to the presence of the bollard before a vehicle approaches the electric vehicle charger 102. In some examples, the reflective rings are formed from retroreflective tape or molded-in reflective elements integrated into the plastic cover 220.

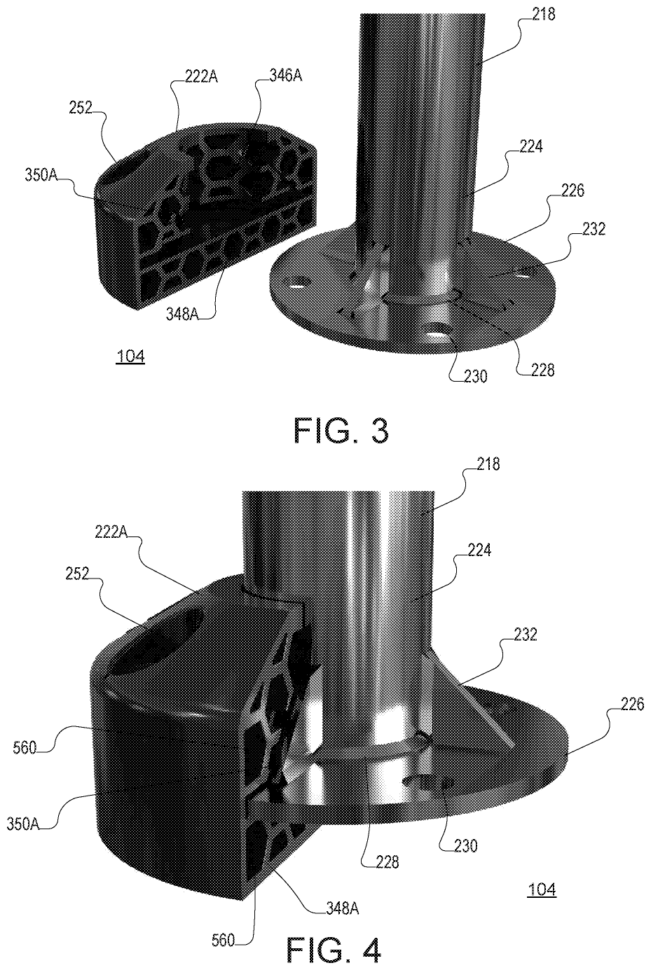

In some examples, the bumper assembly 222 is made of an elastomeric material (e.g., ethylene propylene diene monomer (EPDM) rubber or another suitable elastomer) and includes a first half 222A and a second half 222B. Referring to FIGS. 3 and 4, the first half 222A and its interaction with the proximal end 228 of the inner core 218 is shown in detail. It should be noted that the second half 222B is substantially a mirror image of the first half 222A and is omitted from the figures for the sake of simplifying the description.

Each half 222A, 222B of the bumper assembly 222 has a compressible upper portion 350A and a compressible lower portion 348A that together form flange-receiving cavities 346A. The flange-receiving cavities 346A are each sized and shaped to accommodate one half of the hollow metal tube 224, flange 226, and reinforcing gussets 232 at the proximal end 228 of the inner core 218.

When the two halves 222A, 222B of the bumper assembly 222 are installed on the proximal end 228 of the inner core 218 (like closing a clamshell), the hollow metal tube 224, flange 226, and reinforcing gussets 232 at the proximal end 228 of the inner core 218 are received in the flange-receiving cavities 346A with the flange 226 of the inner core 218 resting on the compressible lower portions 348A and under the compressible upper portions 350A of the halves 222A, 222B of the bumper assembly 222. The flange 226 is therefore separated from the installation surface (e.g., the concrete slab 104) by the compressible lower portions 348A and is held captive in the flange-receiving cavities 346A (e.g., each flange receiving cavity retains the flange such that it is captured in the cavity). Because the compressible lower portions 348A are interposed between the flange 226 and the installation surface (e.g., the concrete slab 104), the flange 226 is elevated above the installation surface and the steel inner core 218 does not directly contact the installation surface, thereby preventing the transmission of rigid point loads from the steel inner core 218 into the slab 104 during a vehicle impact.

Referring again to FIG. 2, the first half 222A and the second half 222B of the bumper assembly 222 also include anchor receptacles 252 that extend through both halves 222A, 222B of the bumper assembly 222 and are aligned with the through-holes 230 in the flange 226. In some examples, each anchor receptacle 252 includes a counterbored or stepped upper region that is sized to receive a washer 254. The bollard 100 is attached to the installation surface (e.g., the concrete slab 104) by inserting the anchors 234 together with the washers 254 into the anchor receptacles 252, passing the anchors 234 through the through-holes 230 in the flange 226, and driving the anchors 234 into the installation surface. The washers 254 seat within the counterbored upper regions of the anchor receptacles 252, preventing the anchors 234 from passing entirely through the anchor receptacles 252. In this configuration, the washers 254 bear against the upper compressible portions 350A of the halves 222A, 222B of the bumper assembly 222 and hold the flange 226 captive between the upper compressible portions 350A and the lower compressible portions 348A. The anchors 234 in some examples are expansion-type concrete anchors, e.g., ½ inch diameter by 6 inch length concrete anchors, though epoxy-set threaded rods, cast-in-place anchor bolts, or adhesive anchors may be substituted depending on the slab material and thickness.

In operation, when the impact-absorbing bollard 100 is struck by a vehicle, the inner core 218 is caused to deflect away from the direction of the impact. As the inner core 218 deflects, portions of the bumper assembly 222 that reside between the washers 254 and the installation surface are compressed, absorbing the kinetic energy of the impact and reducing the force transmitted or transferred into the concrete slab 104. When the impact subsides, the compressed elastomeric portions of the bumper assembly 222 decompress and, due to the elastic memory of the elastomeric material, return the inner core 218 and the rest of the impact-absorbing bollard 100 to its original, undeflected position. In some examples, this self-restoring behavior is maintained across multiple successive impacts up to a threshold force, above which permanent deformation of the bumper assembly 222 or the inner core 218 may occur. The self-restoring behavior reduces the need for post-impact maintenance and keeps the bollard 100 functional as a protective barrier without requiring inspection after every minor vehicle contact.

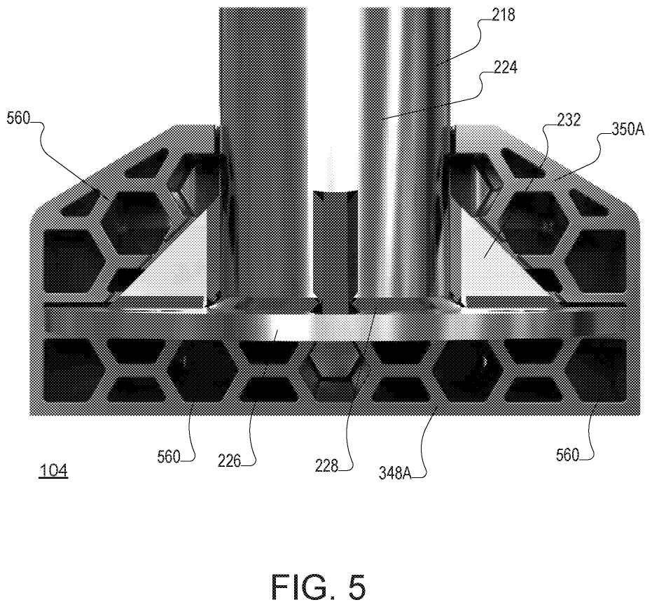

Referring to FIGS. 3-5, in some examples, the first half 222A and the second half 222B of the bumper assembly 222 each have hexagonal-shaped channels 560 (sometimes referred to as “cells,” and some of which may have partial hexagonal shapes), resulting in a honeycomb structure in the interior of the halves 222A, 222B. The hexagonal-shaped channels are open on one end such that, when the two halves 222A, 222B of the bumper assembly 222 are closed together like a clamshell the channels align, forming a substantially continuous channel through the bumper assembly 222 (e.g., running parallel to the installation surface). In some examples, the substantially continuous channels result in a more uniformly compressible bumper assembly 222 than if the channels were closed (e.g., with a wall closing the interior ends of the two halves 222A, 222B) because the closed channels would create an area of increased stiffness in the region of the bumper assembly 222 where the two halves 222a, 222b meet.

In some examples, the size of the hexagonal-shaped channels 560 and/or the thickness of the walls between the hexagonal-shaped channels can be tuned to achieve a desired impact-absorption characteristic. Furthermore, shapes other than hexagons (e.g., square, circular, octagonal, etc.) can be used to form some or all of the channels 560. Variations in shape, size, and thickness can also be used to form an impact-absorption gradient across the bumper assembly 222.

### 2.2 Sign Assembly

Referring again to FIG. 2, the sign assembly 116 includes a coupler 240, a signpost 242, and a sign placard 244. The coupler 240 is a bracket or clamp-type connector that attaches to the distal end 236 of the inner core 218 using one or more fasteners and/or set screws. In some examples, the coupler 240 includes a pair of flanged plates that clamp around the distal end 236 of the inner core 218 and define an opening or channel through which a proximal end 241 of the signpost 242 is inserted and secured. The sign placard 244 attaches to a distal end 243 of the signpost 242 using fasteners. When the impact-absorbing bollard 100 is assembled, the signpost 242 extends through the opening 238 in the plastic cover 220 such that the plastic cover 220 surrounds the inner core 218 below the coupler 240 and the signpost 242 extends above the plastic cover 220.

### 3 Alternatives

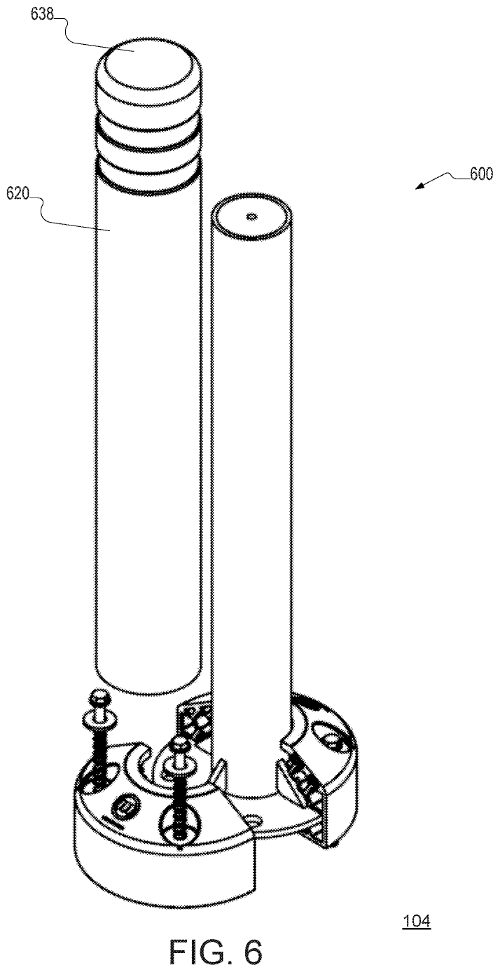

Referring to FIG. 6, another embodiment of an impact-absorbing bollard 600 is similar to the bollard 100 of FIG. 2 but does not include a sign assembly. As such, the distal end 638 of the plastic cover 620 does not have an opening to accommodate a sign post.

In some examples, the concrete slab 104 is configured as a system to accommodate the EV charger 102 by housing wiring (e.g., a bus), which connects the EV charger 102 to a power grid. Similarly, in some examples, the concrete slab 104 is configured to also accommodate the bollard 100 via, e.g., premade holes for the anchoring mechanisms or an imprint for placement of the bollard 100, which may, for example, increase the impact-absorbing qualities of the bollard 100. However, in other examples, the concrete slab may be created without housing or other built-in mechanisms for the accommodation of the installation of the bollard 100, and, in such examples, the bollard 100 may instead be separately installed after the concrete slab has itself been installed in its resting location (in this example, abutting the parking space).

In some examples, the walls of the bumper assembly are in a range of ⅛″ to 1″ thick. In some examples, the walls of the bumper are at least 1/16″ thick.

In some examples, the gussets of the inner core provide structural stability, including strengthening the attachment of the flange to the hollow metal tube and reinforcing the distal end of the inner core against bending when the bollard is struck.

In some examples, the plastic cover extends along a length of the inner core. In other examples, the plastic cover rests (e.g., in a notch) on a top end of the bumper assembly.

In some examples, the flanges of the inner core are designed to fit into the halves of the bumper assembly such that the through holes in the flange are aligned with the anchor receptacles in the halves of the bumper assembly.

In some examples, the lower compressible portions of the halves of the bumper assembly have a thickness in the range of 1″ to 2″ (e.g., 1.5″). This thickness allows for sufficient compression of the bumper assembly when the impact-absorbing bollard is struck, minimizing cracking of the concrete slab and damage to a vehicle.

In some examples, the bumper assembly includes three or more segments rather than two halves. A three-part or multi-part bumper assembly may simplify tooling for complex geometries or accommodate inner cores of varying diameters without redesigning the entire bumper assembly.

In some examples, the bumper assembly is non-circular in cross-section. For example, the bumper assembly may be square, rectangular, or polygonal in cross-section. A non-circular bumper assembly may provide directionally asymmetric impact response, for example being stiffer on the side of the bumper assembly facing oncoming traffic and more compliant on the side facing the electric vehicle charger.

In some examples, the plastic cover incorporates LED lighting elements, for example disposed around, adjacent to, or within the reflective rings, to increase nighttime visibility of the impact-absorbing bollard. In some such examples, wiring for the LED lighting elements is routed through the hollow interior of the inner core.

In some examples, the inner core uses a square, rectangular, or oval hollow metal tube rather than a round tube. A square inner core tube may simplify a method of attachment of the coupler and sign assembly by providing flat surfaces against which the coupler can clamp without rotation.

In some examples, the concrete slab is pre-cast with a recessed region, boss, or imprint shaped in a way to receive the bumper assembly, such that the outer profile of the bumper assembly nests within or flush with the slab surface. This configuration further lowers the profile of the bollard installation and provides additional lateral retention of the bumper assembly against horizontal forces.

In some examples, the inner core includes telescoping sections that allow the effective height of the impact-absorbing bollard to be adjusted after installation, accommodating different vehicle heights or site requirements.

In some examples, the walls of the bumper assembly vary in thickness across both the vertical and radial extents of the bumper assembly to create a three-dimensional stiffness gradient. For example, the walls may be thicker near the installation surface, where slab protection is most critical, and thinner near the top of the bumper assembly, where vehicle bumper contact first occurs and where a softer response is desirable to protect the vehicle.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent and thus can be performed in an order different from that described.

What is claimed is:

1. An impact-absorbing bollard comprising:
a post having a first end and a second end, the post having a flange disposed at the first end;
a two-part bumper assembly including
a first part having a first interior wall, the first interior wall defining
a first cavity sized and shaped to receive a first half of the first end of the post, and
a first plurality of open channels within the first part,
a second part having a second interior wall, the second interior wall defining
a second cavity sized and shaped to receive a second half of the first end of the post, and
a second plurality of open channels within the second part,
wherein, when the two-part bumper assembly is assembled
the first cavity and the second cavity form an assembled cavity that is sized and shaped to receive the first end of the post and has an opening through which the post extends out of the bumper assembly, and
at least some channels of the first plurality of open channels align with at least some channels of the second plurality of open channels to form closed channels that extend through the bumper assembly; and
at least one anchor assembly configured to extend through the two-part bumper assembly and the flange of the post to anchor the bollard to a surface.

2. The impact-absorbing bollard of claim 1 wherein the two-part bumper assembly has a circular shape and the first part and second part of the two-part bumper assembly are semicircular, each having a flat side.

3. The impact-absorbing bollard of claim 2 wherein openings of the first plurality of open channels are on the flat side of the first part of the two-part bumper assembly and the openings of the second plurality of open channels are on the flat side of the second part of the two-part bumper assembly.

4. The impact-absorbing bollard of claim 1 wherein channels of the first plurality of open channels and the second plurality of open channels have a hexagonal shape.

5. The impact-absorbing bollard of claim 4 wherein the first plurality of open channels and the second plurality of open channels form a honeycomb structure in the two-part bumper assembly.

6. The impact-absorbing bollard of claim 1 wherein a size and shape of the first plurality of open channels and the second plurality of open channels varies across the two-part bumper assembly.

7. The impact-absorbing bollard of claim 1 wherein the two-part bumper assembly is formed from an elastomer material.

8. The impact-absorbing bollard of claim 1 wherein the first part of the two-part bumper assembly has an upper portion and a lower portion and the at least one anchor assembly holds the flange between the upper portion and the lower portion.

9. The impact-absorbing bollard of claim 1 further comprising one or more gussets connecting the post to the flange.

10. The impact-absorbing bollard of claim 9 wherein the one or more gussets are configured for insertion into the first cavity and the second cavity in a way that registers one or more openings in the flange with one or more openings in the two-part bumper assembly.

11. The impact-absorbing bollard of claim 1 further comprising a plastic cover configured to receive the post.

12. The impact-absorbing bollard of claim 11 further comprising a signpost assembly attached to the second end of the post.

13. The impact-absorbing bollard of claim 8, wherein the lower portion of the first part and a lower portion of the second part of the two-part bumper assembly together elevate the flange above the surface when the impact-absorbing bollard is anchored to the surface, such that the post does not contact the surface during deflection of the post caused by an impact.

14. The impact-absorbing bollard of claim 1, wherein the at least one anchor assembly comprises an anchor and a washer, the washer being sized to seat within an anchor receptacle defined in the two-part bumper assembly such that the washer prevents the anchor from passing entirely through the anchor receptacle and retains the flange captive between an upper portion and a lower portion of the two-part bumper assembly.

15. The impact-absorbing bollard of claim 11, wherein the plastic cover includes one or more reflective elements disposed around an outer surface of the plastic cover.

16. The impact-absorbing bollard of claim 12, wherein the signpost assembly comprises a coupler attached to the second end of the post and a signpost extending from the coupler, the signpost passing through an opening defined in the plastic cover.

17. The impact-absorbing bollard of claim 1, wherein a wall thickness of walls separating adjacent channels of the first plurality of open channels and a wall thickness of walls separating adjacent channels of the second plurality of open channels vary across the two-part bumper assembly to define a stiffness gradient within the two-part bumper assembly.

18. The impact-absorbing bollard of claim 7, wherein the elastomer material is ethylene propylene diene monomer rubber.

19. A method of protecting an electric vehicle charger installed on a surface, the method comprising:
anchoring an impact-absorbing bollard to the surface between a parking space and the electric vehicle charger, the anchoring including
positioning a two-part bumper assembly around a flange at a first end of a post of the impact-absorbing bollard, the two-part bumper assembly having a first part with a first plurality of open channels and a second part with a second plurality of open channels, wherein at least some channels of the first plurality of open channels align with at least some channels of the second plurality of open channels to form closed channels extending through the two-part bumper assembly, and
driving at least one anchor through the two-part bumper assembly and the flange into the surface such that the flange is captured between an upper portion and a lower portion of the two-part bumper assembly.

20. A system comprising:
a slab;
an electric vehicle charger installed on the slab; and
an impact-absorbing bollard anchored to the slab between a parking space and the electric vehicle charger, the impact-absorbing bollard including:
a post having a first end and a second end, the post having a flange disposed at the first end,
a two-part bumper assembly formed from an elastomeric material, the two-part bumper assembly surrounding the first end of the post and including a first part having a first plurality of open channels and a second part having a second plurality of open channels,
wherein at least some channels of the first plurality of open channels align with at least some channels of the second plurality of open channels to form closed channels extending through the two-part bumper assembly, the closed channels being configured to compress when the post is deflected by an impact, and
at least one anchor extending through the two-part bumper assembly and the flange into the slab, wherein the two-part bumper assembly elevates the flange above a surface of the slab and absorbs impact energy through compression of the closed channels to reduce force transferred from the post into the slab.
